(19) United States
(12) Patent Application Publication
(10) Pub. No.: US 2021/0055121 A1
(43) Pub. Date: Feb. 25, 2021

(54) SYSTEMS AND METHODS FOR DETERMINING RECOMMENDED LOCATIONS

(71) Applicant: BEIJING DIDI INFINITY TECHNOLOGY AND DEVELOPMENT CO., LTD., Beijing (CN)

(72) Inventors: Yushu GAO, Beijing (CN); Pengfei XU, Beijing (CN)

(73) Assignee: BEIJING DIDI INFINITY TECHNOLOGY AND DEVELOPMENT CO., LTD., Beijing (CN)

(21) Appl. No.: 17/093,721

(22) Filed: Nov. 10, 2020

Related U.S. Application Data
(63) Continuation of application No. PCT/CN2018/113798, filed on Nov. 2, 2018.

(30) Foreign Application Priority Data
Oct. 31, 2018 (CN) 201811289809.5

(51) Int. Cl. G01C 21/34; G01C 21/16; G01C 21/28; G06K 9/00; G06N 3/02

(52) U.S. Cl. CPC G01C 21/3484; G01C 21/1656; G06N 3/02; G06K 9/00791; G01C 21/28

(57) ABSTRACT

A method for determining a recommended location may include identifying a candidate location based on historical order data of a plurality of historical passengers; obtaining a plurality of images showing sights around the candidate location, wherein the plurality of images are captured by at least one vehicle recorder; determining an identification result as to whether a road element is present around the candidate location based on the plurality of images; and determining whether the candidate location is a recommended location based on the identification result.

### CROSS-REFERENCE TO RELATED APPLICATIONS

This application is a continuation of International Application No. PCT/CN2018/113798, filed on Nov. 2, 2018, which claims priority of Chinese Application No. 201811289809.5, filed on Oct. 31, 2018, the contents of which are incorporated herein in its entirety by reference.

### TECHNICAL FIELD

The present disclosure generally relates to systems and methods for providing online to offline services, and more particularly, to systems and methods for optimizing recommended pick-up locations or recommended drop-off locations in car hailing services.

### BACKGROUND

The development of online to offline services, such as but not limited to online car hailing services, brings remarkable convenience to people's daily lives. During an online car hailing service, the system of the service often recommends locations (e.g., pick-up locations, drop-off locations, etc.) to a passenger to improve user experience. In existing methods for recommending locations, the system often analyzes historical orders to select locations used by a large number of passengers in the historical orders as recommended locations. However, the problem of the existing methods is that the recommended locations based on purely on usage in historical orders are often unreasonable and/or lack timely updates. For example, at or around the recommended locations, there may be obstacles that passengers have to get around (sometime by breaking rules) to access a car, or the driver cannot legally stop the car to pick up (or drop off) the passenger. The obstacles, such as fences, electronic eyes, yellow grid lines, no-stop lines, etc., are often not in a searchable road network system. As another example, the fast-changing city roads often renders it necessary to frequently update the recommended locations, which is impossible for the existing methods. Therefore, with the existing methods, the online car hailing system sometimes fails to identify or timely update the obstacles to optimize the recommended locations. It is desirable to provide systems and methods for determining recommended locations, and more particularly for optimizing recommended locations.

### SUMMARY

An aspect of the present disclosure introduces a system for determining a recommended location, comprising: at least one network interface to communicate with at least one vehicle recorder; at least one storage medium including a set of instructions; and at least one processor in communication with the at least one storage medium and operably connected to the at least one network interface. Wherein when executing the set of instructions, the at least one processor is directed to: identify a candidate location based on historical order data of a plurality of historical passengers; obtain a plurality of images, via the at least one network interface, showing sights around the candidate location, wherein the plurality of images are captured by the at least one vehicle recorder; determine an identification result as to whether a road element is present around the candidate location based on the plurality of images; and determine whether the candidate location is a recommended location based on the identification result.

In some embodiments, wherein to determine the identification result, the at least one processor is further directed to: for each of the plurality of images, identify whether the image includes the road element is present around the candidate location based on a deep learning neural network.

In some embodiments, the identification result is that the road element is not present and the candidate location is determined as the recommended location.

In some embodiments, the identification result is that the road element is present and the at least one processor is further directed to: determine at least one of: a location of the road element; an area of the road element; or a height of the road element.

In some embodiments, the road element is a fence, and the at least one processor is further directed to: determine that the area of the fence is discontinuous; and determine that the candidate location is the recommended location.

In some embodiments, the road element includes at least one of: a fence, an electronic eye, a traffic light, a traffic sign, a yellow grid line, or a no-stop line along the road.

In some embodiments, the at least one processor is further directed to: send an instruction to the at least one vehicle recorder via the at least one network interface to record the images, wherein one of the at least one vehicle recorder is mounted on a vehicle.

In some embodiments, the at least one processor is further directed to: obtain GPS data of a plurality of vehicles via the at least one network interface; and determine whether one or more of the plurality of vehicles are around the candidate location based on the GPS data.

In some embodiments, the at least one processor is further directed to: in response to a determination that the one or more vehicles are around the candidate location, obtain at least one video around the candidate location from the at least one vehicle recorder corresponding to the one or more vehicles; wherein the plurality of images are extracted from the at least one video, and each of the plurality of images includes location information.

In some embodiments, the at least one processor is further directed to: obtain a trigger condition to send the instruction to the at least one vehicle recorder, wherein the trigger condition includes a complaint from a passenger or a feedback from a driver.

In some embodiments, to determine the identification result, the at least one processor is further directed to: for each of the at least one vehicle recorder, obtain at least one image, via the at least one network interface, showing sights around the candidate location, wherein the at least one image is captured by the vehicle record; and verify the identification result based on the at least one image captured by each of the at least one vehicle recorder.

In some embodiments, the candidate location is a candidate pick-up location or a candidate drop-off location.

According to another aspect of the present disclosure, a method for determining a recommended location, comprising: identifying a candidate location based on historical order data of a plurality of historical passengers; obtaining a plurality of images showing sights around the candidate location, wherein the plurality of images are captured by at least one vehicle recorder; determining an identification result as to whether a road element is present around the candidate location based on the plurality of images; and determining whether the candidate location is a recommended location based on the identification result.

In some embodiments, the determining of the identification result includes: for each of the plurality of images, identifying whether the road element is present around the candidate location based on a deep learning neural network.

In some embodiments, the identification result is that the road element is not present and the candidate location is determined as the recommended location.

In some embodiments, the identification result is that the road element is present, and the method further comprising: determining at least one of: a location of the road element; an area of the road element; or a height of the road element.

In some embodiments, the road element is a fence, and the method further comprising: determining that the area of the fence is discontinuous; and determining that the candidate location is the recommended location.

In some embodiments, the road element includes at least one of: a fence, an electronic eye, a traffic light, a traffic sign, a yellow grid line, or a no-stop line along the road.

In some embodiments, the method may further include: sending an instruction to the at least one vehicle recorder via the at least one network interface to record the images, wherein one of the at least one vehicle recorder is mounted on a vehicle.

In some embodiments, the method may further include: obtaining GPS data of a plurality of vehicles; and determining whether one or more of the plurality of vehicles are around the candidate location based on the GPS data.

In some embodiments, the method may further includes: in response to a determination that the one or more vehicles are around the candidate location, obtaining at least one video around the candidate location from the at least one vehicle recorder corresponding to the one or more vehicles; wherein the plurality of images are extracted from the at least one video, and each of the plurality of images includes location information.

In some embodiments, the method may further include: obtaining a trigger condition to send the instruction to the at least one vehicle recorder, wherein the trigger condition includes a complaint from a passenger or a feedback from a driver.

In some embodiments, the determining of the identification result further includes: for each of the at least one vehicle recorder, obtaining at least one image showing sights around the candidate location, wherein the at least one image is captured by the vehicle record; and verifying the identification result based on the at least one image captured by each of the at least one vehicle recorder.

In some embodiments, the candidate location is a candidate pick-up location or a candidate drop-off location.

According to still another aspect of the present disclosure, a non-transitory computer readable medium, comprising at least one set of instructions compatible for determining a recommended location, wherein when executed by at least one processor of one or more electronic device, the at least one set of instructions directs the at least one processor to: identify a candidate location based on historical order data of a plurality of historical passengers; obtain a plurality of images showing sights around the candidate location, wherein the plurality of images are captured by at least one vehicle recorder; determine an identification result as to whether a road element is present around the candidate location based on the plurality of images; and determine whether the candidate location is a recommended location based on the identification result.

According to still another aspect of the present disclosure, a system for determining a recommended location, comprising: a candidate location identifying module, configured to identify a candidate location based on historical order data of a plurality of historical passengers; an image obtaining module, configured to obtain a plurality of images showing sights around the candidate location, wherein the plurality of images are captured by at least one vehicle recorder; an identification module, configured to determine an identification result as to whether a road element is present around the candidate location based on the plurality of images; and a recommended location determining module, configured to determine whether the candidate location is a recommended location based on the identification result.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary online to offline service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process for determining a recommended location according to some embodiments of the present disclosure;

FIG. 6 is a schematic diagram illustrating an exemplary image showing sights around a candidate location according to some embodiments of the present disclosure; and

FIG. 7 is a flowchart illustrating an exemplary process for obtaining at least one video around a candidate location according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to systems and methods for determining recommended locations. To this end, the systems and methods may obtain images showing sights around a candidate location (e.g., a historical pick-up location or drop-off location used by a large number of historical passengers). Herein the term “location” refers to position or site that are clearly identifiable and can be used by users of an online to offline service (e.g. passengers or drivers of an online car hailing service). Herein, the phrase “sights around a candidate location” refers to whatever is observable and/or viewable close to or at the candidate location. The systems and methods may identify whether there are obstacles around the candidate location in the obtained images. The obstacles, such as a fence, an electronic eye, a traffic light, a traffic sign, a yellow grid line, a no-stop line along the road, etc., may prevent or delay a passenger from accessing a car without breaking any rules (e.g. laws and regulations related to pedestrian behavior) or prevent or delay a driver from stopping the car to pick-up or drop-off the passenger without breaking any rules (e.g. laws and regulations related to vehicles and drivers). The images may be captured by vehicle recorders of vehicles when the vehicles are driving around the candidate location. In some embodiments, the vehicle recorder can be an integrated part of the vehicle. In some embodiments, the vehicle recorder can be a mobile device (e.g. car camera/video camera, or a mobile phone/pad with a camera). In some embodiments, the systems and methods may use a deep learning neural network to identify the obstacles in the images. In this way, the systems and methods may determine whether the candidate location is reasonable/operable to recommend to a passenger or a driver, and the recommended locations may be optimized.

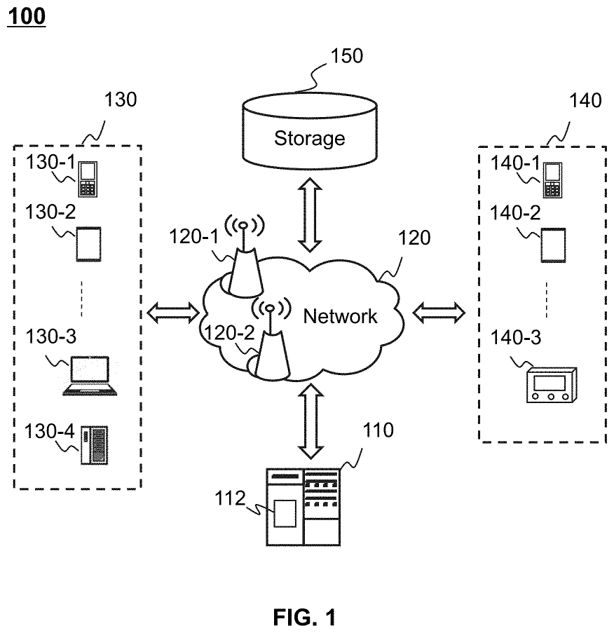

FIG. 1 is a schematic diagram of an exemplary online to offline system 100 according to some embodiments of the present disclosure. For example, the online to offline system 100 may be an online to offline service platform for providing services such as taxi hailing, chauffeur services, delivery vehicles, carpool, bus service, driver hiring, shuttle services, online navigation services, etc. The online to offline system 100 may include a server 110, a network 120, a user terminal 130, a vehicle recorder 140, and a storage 150. The server 110 may include a processing engine 112.

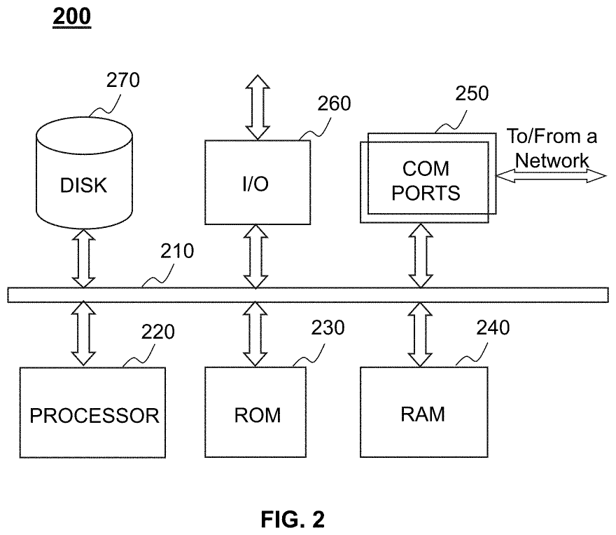

The server 110 may be configured to process information and/or data relating to determining recommended locations. For example, the server 110 may identify a candidate location based on historical order data of a plurality of historical passengers, and obtain a plurality of images showing sights around the candidate location. As another example, the server 110 may determine an identification result as to whether a road element is present around the candidate location based on the images. As still another example, the server 110 may determine whether the candidate location is a recommended location based on the identification result. In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the user terminal 130, the vehicle recorder 140, and/or the storage 150 via the network 120. As another example, the server 110 may connect the user terminal 130, the vehicle recorder 140, and/or the storage 150 to access stored information and/or data. In some embodiments, the server 110 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to determining recommended locations to perform one or more functions described in the present disclosure. For example, the processing engine 112 may identify a candidate location based on historical order data of a plurality of historical passengers, and obtain a plurality of images showing sights around the candidate location. As another example, the processing engine 112 may determine an identification result as to whether a road element is present around the candidate location based on the images. As still another example, the processing engine 112 may determine whether the candidate location is a recommended location based on the identification result. In some embodiments, the processing engine 112 may include one or more processing engines (e.g., single-core processing engine(s) or multi-core processor(s)). Merely by way of example, the processing engine 112 may be one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the online to offline system 100 (e.g., the server 110, the user terminal 130, the vehicle recorder 140, and the storage 150) may transmit information and/or data to other component(s) in the online to offline system 100 via the network 120. For example, the server 110 may obtain a plurality of images showing sights around the candidate location from the vehicle recorder 140 via the network 120. As another example, the server 110 may send an instruction to the vehicle recorder 140 to record a video via the network 120. As still another example, the server 110 may obtain GPS data of a vehicle via the network 120. In some embodiments, the network 120 may be any type of wired or wireless network, or combination thereof. Merely by way of example, the network 130 may be a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the online to offline system 100 may be connected to the network 120 to exchange data and/or information between them.

The user terminal 130 may be any electronic device used by a user of the online to offline service. In some embodiments, the user terminal 130 may be a mobile device 130-1, a tablet computer 130-2, a laptop computer 130-3, a desktop computer 130-4, or the like, or any combination thereof. In some embodiments, the mobile device 130-1 may be a wearable device, a smart mobile device, a virtual reality device, an augmented reality device, or the like, or any combination thereof. In some embodiments, the wearable device may be a smart bracelet, a smart footgear, a smart glass, a smart helmet, a smart watch, a smart clothing, a smart backpack, a smart accessory, or the like, or any combination thereof. In some embodiments, the smart mobile device may be a smartphone, a personal digital assistance (PDA), a gaming device, a navigation device, a point of sale (POS) device, or the like, or any combination thereof. In some embodiments, the virtual reality device and/or the augmented reality device may be a virtual reality helmet, a virtual reality glass, a virtual reality patch, an augmented reality helmet, an augmented reality glass, an augmented reality patch, or the like, or any combination thereof. For example, the virtual reality device and/or the augmented reality device may be a Google Glass™, a RiftCon™, a Fragments™, a Gear VR™, etc. In some embodiments, the desktop computer 130-4 may be an onboard computer, an onboard television, etc.

In some embodiments, the user terminal 130 may be a device with positioning technology for locating the position of the user and/or the user terminal 130. The positioning technology used in the present disclosure may be a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

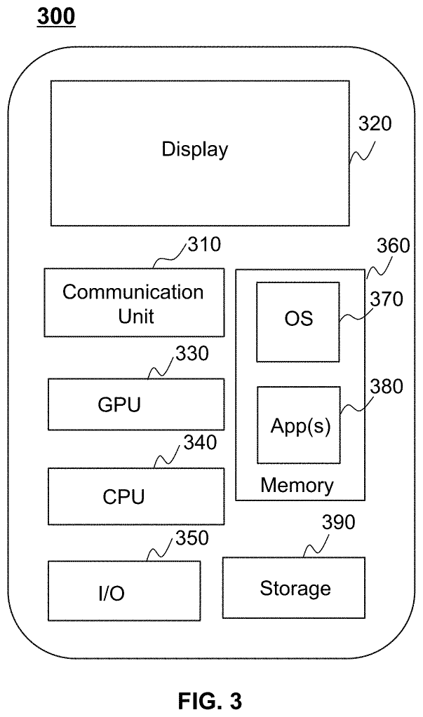

In some embodiments, the user terminal 130 may further include at least one network port. The at least one network port may be configured to send information to and/or receive information from one or more components in the online to offline system 100 (e.g., the server 110, the storage 150) via the network 120. In some embodiments, the user terminal 130 may be implemented on a computing device 200 having one or more components illustrated in FIG. 2, or a mobile device 300 having one or more components illustrated in FIG. 3 in the present disclosure.

The vehicle recorder 140 may be any electronic device equipped with cameras for capturing images or videos. In some embodiments, the vehicle recorder 140 may be an electronic device mounted on a vehicle for recording sights inside or outside the vehicle. For example, the vehicle recorder 140 may be a mobile device 140-1, a tablet computer 140-2, a data recorder 140-3, or the like, or any combination thereof. In some embodiments, the vehicle recorder 140 may be an integrated part of the vehicle. In some embodiments, the vehicle recorder 140 may be a mobile device (e.g. car camera/video camera, or a mobile phone/pad with a camera). In some embodiments, the vehicle recorder 140 may be a device with positioning technology for locating the position of the vehicle. In some embodiments, the vehicle recorder 140 may further include at least one network port. The at least one network port may be configured to send information to and/or receive information from one or more components in the online to offline system 100 (e.g., the server 110, the storage 150) via the network 120. In some embodiments, the vehicle recorder 140 may be implemented on a computing device 200 having one or more components illustrated in FIG. 2, or a mobile device 300 having one or more components illustrated in FIG. 3 in the present disclosure.

The storage 150 may store data and/or instructions. For example, the storage 150 may store videos or images captured by the vehicle recorder 140. As another example, the storage 150 may store candidate locations and/or recommended locations. As still another example, the storage 150 may store data and/or instructions that the server 110 may execute or use to perform exemplary methods described in the present disclosure. In some embodiments, the storage 150 may be a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof.

In some embodiments, the storage 150 may include at least one network port to communicate with other devices in the online to offline system 100. For example, the storage 150 may be connected to the network 120 to communicate with one or more components of the online to offline system 100 (e.g., the server 110, the user terminal 130, the vehicle recorder 140) via the at least one network port. One or more components in the online to offline system 100 may access the data or instructions stored in the storage 150 via the network 120. In some embodiments, the storage 150 may be directly connected to or communicate with one or more components in the online to offline system 100 (e.g., the server 110, the user terminal 130, the vehicle recorder 140). In some embodiments, the storage 150 may be part of the server 110.

In some embodiments, one or more components of the online to offline system 100 (e.g., the server 110, the user terminal 130, the vehicle recorder 140) may access the storage 150. For example, the server 110 of the online to offline system 100 may load the images and/or candidate location for determining whether the candidate location is a recommended location.

In some embodiments, one or more components of the online to offline system 100 (e.g., the server 110, the user terminal 130, the vehicle recorder 140, and the storage 150) may communicate with each other in form of electronic and/or electromagnetic signals, through wired and/or wireless communication. In some embodiments, the online to offline system 100 may further include at least one information exchange port. The at least one exchange port may be configured to receive information and/or send information relating to determining the recommended locations (e.g., in form of electronic signals and/or electromagnetic signals) between any electronic devices in the online to offline system 100. In some embodiments, the at least one information exchange port may be one or more of an antenna, a network interface, a network port, or the like, or any combination thereof. For example, the at least one information exchange port may be a network port connected to the server 110 to send information thereto and/or receive information transmitted therefrom.

FIG. 2 is a schematic diagram illustrating exemplary hardware and software components of a computing device 200 on which the server 110, and/or the user terminal 130 may be implemented according to some embodiments of the present disclosure. For example, the processing engine 112 may be implemented on the computing device 200 and configured to perform functions of the processing engine 112 disclosed in this disclosure.

The computing device 200 may be used to implement an online to offline system 100 for the present disclosure. The computing device 200 may be used to implement any component of online to offline system 100 that perform one or more functions disclosed in the present disclosure. For example, the processing engine 112 may be implemented on the computing device 200, via its hardware, software program, firmware, or a combination thereof. Although only one such computer is shown, for convenience, the computer functions relating to the online to offline service as described herein may be implemented in a distributed fashion on a number of similar platforms, to distribute the processing load.

The computing device 200, for example, may include COM ports 250 connected to and from a network connected thereto to facilitate data communications. The COM port 250 may be any network port or information exchange port to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The processing circuits may also generate electronic signals including the conclusion or the result (e.g., the recommended location) and a triggering code. In some embodiments, the trigger code may be in a format recognizable by an operation system (or an application installed therein) of an electronic device (e.g., the user terminal 130) in the online to offline system 100. For example, the trigger code may be an instruction, a code, a mark, a symbol, or the like, or any combination thereof, that can activate certain functions and/or operations of a mobile phone or let the mobile phone execute a predetermined program(s). In some embodiments, the trigger code may be configured to rend the operation system (or the application) of the electronic device to generate a presentation of the conclusion or the result (e.g., the recommended location) on an interface of the electronic device. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for storing various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The exemplary computing device may also include operation systems stored in the ROM 230, RAM 240, and/or other type of non-transitory storage medium to be executed by the processor 220. The program instructions may be compatible with the operation systems for providing the online to offline service. The computing device 200 also includes an I/O component 260, supporting input/output between the computer and other components. The computing device 200 may also receive programming and data via network communications.

Merely for illustration, only one processor is illustrated in FIG. 2. Multiple processors are also contemplated; thus, operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

FIG. 3 is a schematic diagram illustrating exemplary hardware and/or software components of an exemplary mobile device 300 on which the user terminal 130 may be implemented according to some embodiments of the present disclosure.

As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™ Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the recommended location. User interactions with the information stream may be achieved via the I/O devices 350 and provided to the processing engine 112 and/or other components of the system 100 via the network 120.

To implement various modules, units, and their functionalities described in the present disclosure, computer hardware platforms may be used as the hardware platform(s) for one or more of the elements described herein (e.g., the online to offline system 100, and/or other components of the online to offline system 100 described with respect to FIGS. 1-7). The hardware elements, operating systems and programming languages of such computers are conventional in nature, and it is presumed that those skilled in the art are adequately familiar therewith to adapt those technologies to determine a recommended location as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

One of ordinary skill in the art would understand that when an element of the online to offline system 100 performs, the element may perform through electrical signals and/or electromagnetic signals. For example, when a server 110 processes a task, such as determining whether a candidate location is a recommended location, the server 110 may operate logic circuits in its processor to process such task. When the server 110 completes determining the recommended location, the processor of the server 110 may generate electrical signals encoding the recommended location. The processor of the server 110 may then send the electrical signals to at least one information exchange port of a target system associated with the server 110. The server 110 communicates with the target system via a wired network, the at least one information exchange port may be physically connected to a cable, which may further transmit the electrical signals to an input port (e.g., an information exchange port) of the user terminal 130. If the server 110 communicates with the target system via a wireless network, the at least one information exchange port of the target system may be one or more antennas, which may convert the electrical signals to electromagnetic signals. Within an electronic device, such as the user terminal 130, and/or the server 110, when a processor thereof processes an instruction, sends out an instruction, and/or performs an action, the instruction and/or action is conducted via electrical signals. For example, when the processor retrieves or saves data from a storage medium (e.g., the storage 150), it may send out electrical signals to a read/write device of the storage medium, which may read or write structured data in the storage medium. The structured data may be transmitted to the processor in the form of electrical signals via a bus of the electronic device. Here, an electrical signal may be one electrical signal, a series of electrical signals, and/or a plurality of discrete electrical signals.

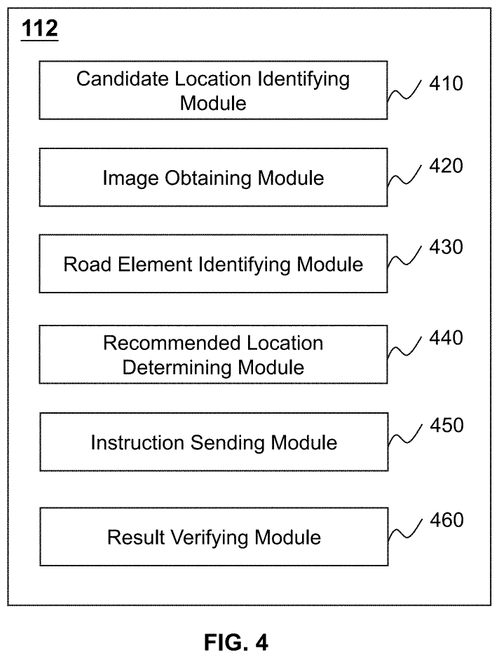

FIG. 4 is a block diagram illustrating an exemplary processing engine 112 according to some embodiments of the present disclosure. As illustrated in FIG. 4, the processing engine 112 may include a candidate location identifying module 410, an image obtaining module 420, a road element identifying module 430, a recommended location determining module 440, an instruction sending module 450, and a result verifying module 460.

The candidate location identifying module 410 may be configured to identify candidate locations. For example, the candidate location identifying module 410 may be configured to identify a candidate location based on historical order data of a plurality of historical passengers.

The image obtaining module 420 may be configured to obtain a plurality of images showing sights around the candidate location. For example, the image obtaining module 420 may obtain GPS data of a plurality of vehicles. The image obtaining module 420 may determine whether one or more of the plurality of vehicles are around the candidate location based on the plurality of vehicles. As another example, in response to a determination that the one or more vehicles are around the candidate location, the image obtaining module 420 may obtain at least one video around the candidate location from the at least one vehicle recorder corresponding to the one or more vehicles. The image obtaining module 420 may extract the plurality of images showing sights around the candidate location from the at least one video.

The road element identifying module 430 may be configured to determine an identification result as to whether a road elements is present around the candidate location based on the plurality of images. For example, the road element identifying module 430 may identify the road element according to a deep learning neural network. For example, the road element identifying module 430 may train a neural network using a plurality of manually labeled images, and use the trained neural network to predict whether the road element is present around the candidate location in the image. As another example, the road element identifying module 430 may identify the road element according to an image sematic segmentation method. The road element identifying module 430 may group or segment contents in the image according to semantic meanings that pixels express in the image.

The recommended location determining module 440 may be configured to determine whether the candidate location is a recommended location based on the identification result. For example, if the road element that forbids a driver to stop a vehicle, or prevents a passenger from getting on the vehicle is present around the candidate location, the recommended location determining module 440 may determine that the driver cannot stop a vehicle to pick up or drop off the passenger at the candidate location. The recommended location determining module 440 may determine that the candidate location is not reasonable/not operable to recommend to a user (e.g., a passenger, a driver, etc.) of the online to offline service. As another example, if the identification result is that the road element is not present around the candidate location, the recommended location determining module 440 may determine that the driver can stop a vehicle to pick up or drop off the passenger at the candidate location. The recommended location determining module 440 may determine that the candidate location is reasonable/operable as a recommended location.

The instruction sending module 450 may be configured to send an instruction to a vehicle recorder corresponding to a vehicle. For example, in response to a determination that one or more vehicles are around the candidate location, the instruction sending module 450 may send the instruction to the one or more vehicle recorders 140 corresponding to the one or more of the plurality of vehicles.

The result verifying module 460 may be configured to verify the identification result based on a plurality of sub-results to improve an accuracy of the identification. For example, if a predetermined number of sub-results indicate that the road element is present around the candidate location, the result verifying module 460 may determine that the identification result is that the road element is present around the candidate location. Otherwise, the result verifying module 460 may determine that the sub-results include wrong identifications of the road element, and determine that identification result is that the road element is not present around the candidate location.

The modules in the processing engine 112 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the recommended location determining module 440 and the result verifying module 460 may be combined as a single module which may both determine and verify a recommended location. As another example, the processing engine 112 may include a storage module (not shown) used to store data and/or information relating to determining recommended locations.

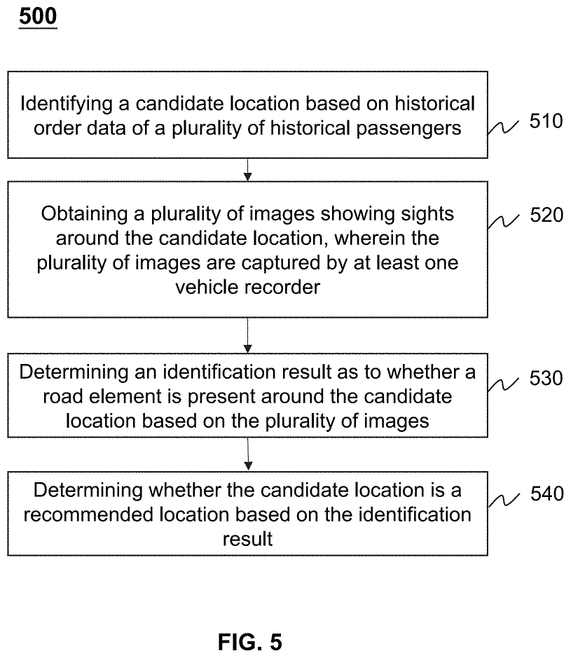

FIG. 5 is a flowchart illustrating an exemplary process 500 for determining a recommended location according to some embodiments of the present disclosure. The process 500 may be executed by the online to offline system 100. For example, the process 500 may be implemented as a set of instructions (e.g., an application) stored in the storage ROM 230 or RAM 240. The processor 220 may execute the set of instructions, and when executing the instructions, it may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process as illustrated in FIG. 5 and described below is not intended to be limiting.

In 510, the processing engine 112 (e.g., the processor 220, the candidate location identifying module 410) may identify a candidate location based on historical order data of a plurality of historical passengers.

In some embodiments, the candidate location may be a historical location or a historical site that are clearly identifiable and used by a majority of users of the online to offline service. In some embodiments, the candidate location may be a historical location used by a number of users that surpass a pre-determined threshold. The candidate location may include a candidate pick-up location, a candidate drop-off location, a candidate point of interest (POI), or the like, or any combination thereof.

In some embodiments, the processing engine 112 may obtain historical order data of a plurality of historical users (e.g., passengers, drivers, service providers, service requesters, etc.) of the online to offline service. The historical order data may be data relating to historical orders that have been completed by the plurality of historical users. For example, in an online car hailing service, the historical order data of a historical order may include a historical pick-up location, a historical drop-off location, a historical start time, a historical end time, a historical payment, or the like, or any combination thereof. The processing engine 112 may extract a plurality of historical locations (e.g., historical pick-up locations, historical drop-off locations) from the historical order data, and analyze the plurality of historical locations to obtain the candidate location. For example, the processing engine 112 may select a historical location that has been used by more than a first predetermined number of users in the history from the plurality of historical locations as the candidate location. In some embodiments, the first predetermined number may be determined according to different areas. For example, in a downtown area, the processing engine 112 may select a historical location that has been used by more than 50 users as the candidate location. As another example, in a suburban area, the processing engine 112 may select a historical location that has been used by more than 10 users as the candidate location.

In some embodiments, the processing engine 112 may obtain the candidate location from a storage device in the online to offline system 100 (e.g., the storage 150) and/or an external data source (not shown) via the network 120. For example, the candidate location may be pre-determined (e.g. by the processing engine 112 or any other platforms or devices) and stored in the storage device in the online to offline system 100. The processing engine 112 may access the storage device and retrieve the candidate location. As another example, the candidate location may be selected for locations used in a predetermined period of time (e.g. 1 day, 1 week, or 1 month) before (e.g. immediate prior to) the time of analysis.

In 520, the processing engine 112 (e.g., the processor 220, the image obtaining module 420) may obtain a plurality of images showing sights around the candidate location. In some embodiments, the plurality of images may be captured by at least one vehicle recorder 140, and be sent to the processing engine 112 and/or the storage 150 via at least one network interface.

In some embodiments, the plurality of images showing sights around the candidate location may be images that include whatever is observable and/or viewable close to or at the candidate location. In some embodiments, the plurality of images showing sights around the candidate location may be captured by the at least one vehicle recorder 140 when the corresponding at least one vehicle is driving around the candidate location. The term “around” used herein may be used to describe a place that is close to or is the candidate location. For example, around the candidate location may include places within a first predetermined distance from the candidate location. The first predetermined distance may be a default distance stored in a storage device (e.g., the storage 150, the storage 390). Additionally or alternatively, the first predetermined distance may be set manually or be determined by one or more components of the online to offline system 100 according to different situations. For example, the first predetermined distance may be determined by the processing engine 112 according to different areas or different roads.

In some embodiments, the processing engine 112 may obtain the plurality of images from the at least one vehicle recorder 140. In some embodiments, the processing engine 112 may obtain a trigger condition in some cases when some time-sensitive events happen. For example, when there is an event or arranged activity in a mall, a fence may be placed at an access point of the road leading to the mall for a short time. A driver may not pass through the access point. As another example, when a traffic accident happens at or around the candidate location, a driver is not allowed to stop at the candidate location until the traffic accident is clear away. The trigger condition may be a trigger signal that whether to send an instruction to the at least one vehicle recorder 140 to capture videos or images, and send to the processing engine 112. In some embodiments, the trigger condition may include a complaint from a passenger, a feedback from a driver, a report from a passerby, or the like, or any combination thereof. For example, the passenger may send a complaint that his/her driver did not pick him/her up at the candidate location predetermined by the passenger to the processing engine 112. The processing 112 may obtain the trigger condition to send the instruction to the at least one vehicle recorder 140. As another example, the driver may send a feedback that the he/she cannot stop at the candidate location to pick up or drop off his/her passenger to the processing engine 112. The processing engine 112 may obtain the trigger condition to send the instruction to the at least one vehicle recorder 140.

In some embodiments, the processing engine 112 may obtain GPS data of a plurality of vehicles of the online to offline service. The GPS data of a vehicle of the plurality of vehicles may be obtained by a user terminal 130 associated with the vehicle, an onboard positioning device of the vehicle, a vehicle recorder 140 of the vehicle, or the like, or any combination thereof. In some embodiments, the processing engine 112 may determine whether the plurality of vehicles are around the candidate location based on the GPS data. For example, the processing engine 112 may obtain real-time locations of the plurality of vehicles from the GPS data, and determine whether the real-time locations are within the first predetermined distance from the candidate location. If the processing engine 112 determines that one or more of the plurality of vehicles arrive around the candidate location, the processing engine 112 (e.g., the instruction sending module 450) may send the instruction to the one or more vehicle recorders 140 corresponding to the one or more of the plurality of vehicles. The one or more vehicle recorders 140 may obtain the instruction and start to capture videos and/or images showing sights around the candidate location. The one or more vehicle recorders 140 may send the captured videos and/or images to the processing engine 112.

In some embodiments, the one or more vehicle recorders 140 for capturing videos and/or images may be a second predetermined number. The second predetermined number may be a default number stored in a storage device (e.g., the storage 150, the storage 390). Additionally or alternatively, the second predetermined number may be set manually or be determined by one or more components of the online to offline system 100 according to different situations. For example, the second predetermined number may be determined according to different areas or roads. In some embodiments, the processing engine 112 may select the second predetermined number of vehicle recorders from the plurality of vehicles that arrive around the candidate location, and send the instruction to the second predetermined number of vehicle recorders. In some embodiments, after sending the instruction to the second predetermined number of vehicle recorders, the processing engine 112 may stop sending the instruction to avoid redundant data.

In some embodiments, the processing engine 112 may extract images from the obtained videos and/or obtained images. For example, the processing engine 112 may select a third predetermined number of images from the obtained videos. The processing engine 112 may extract an image from the obtained videos every several seconds or every several distance intervals to obtain the plurality of images. As another example, the processing engine 112 may select a third predetermined number of images from the obtained images. The third predetermined number may be a default number stored in a storage device (e.g., the storage 150, the storage 390). Additionally or alternatively, the third predetermined number may be set manually or be determined by one or more components of the online to offline system 100 according to different situations. For example, the processing engine 112 may select the third predetermined number of images that have high qualities (e.g., the images are clear showing sights around the candidate location, the images are captured in bright light, etc.) as the plurality of images, in order to improve efficiency and accuracy of an identification result whether a road element is present around the candidate location in the plurality of images.

In 530, the processing engine 112 (e.g., the processor 220, the road element identifying module 430) may determine an identification result as to whether a road elements is present around the candidate location based on the plurality of images.

In some embodiments, the road element may be a facility in a road. The facility may forbid or delay a driver to stop a vehicle without breaking any rules (e.g. laws and regulations related to pedestrian behavior), or prevent or delay a passenger from getting on the vehicle without breaking any rules (e.g. laws and regulations related to pedestrian behavior). For example, the road element may include a fence, an electronic eye, a traffic light, a traffic sign, or the like, or any combination thereof. In some embodiments, the fence may include a plurality of barriers between a walkway and a vehicular traffic lane. The present of the fence in the road may prevent a passenger from getting on a vehicle. In some embodiments, the electronic eye may be a photodetector used for detecting illegal behaviors, such as detecting illegal parking of a vehicle on the road. In some embodiments, the traffic sign may be a no-stop sign that forbid a driver to stop a vehicle. In some embodiments, the road element may be a marked line on/along the road. The marked line may forbid a driver to stop a vehicle. For example, the road element may include a yellow grid line, a no-stop line along the road, a solid yellow line, a white guide line, or the like, or any combination thereof. In some embodiments, the road element may be a particular area that forbid a driver to stop a vehicle. For example, the road element may include a bus stop, a fire equipment, or the like, or any combination thereof.

In some embodiments, the road element that to be identified may be adjusted according to different situations. For example, in different cities, the road elements that to be identified may be different. For example, in Beijing, the processing engine 112 may determine an identification result as to whether a fence is present around the candidate location. In Shenzhen, the processing engine 112 may determine an identification result as to whether a yellow grid line is present around the candidate location.

In some embodiments, for each of the plurality of image, the processing engine 112 may identify whether a road element is present around the candidate location in the image. The processing engine 112 may identify the road element according to a deep learning neural network. For example, the processing engine 112 may train a neural network using a plurality of manually labeled images, and use the trained neural network to predict whether the road element is present around the candidate location in the image. In some embodiments, the processing engine 112 may identify the road element according to an image sematic segmentation method. For example, the processing engine 112 may group or segment contents in the image according to semantic meanings that pixels express in the image.

In some embodiments, after identifying that the road elements is present around the candidate location, the processing engine 112 may further determine a location of the road element. For example, if the identification result is that a fence is present around the candidate location, the processing engine 112 may determine the fence is at the left side of a road, at the right side of the road, or between two roads. In some embodiments, the processing engine 112 may further determine an area of the road element. For example, if the identification result is that a fence is present around the candidate location, the processing engine 112 may determine whether the area of the fence is continuous. If the fence is continuous, the processing engine 112 may determine that a passenger cannot get on or get off a vehicle at the candidate location. If the fence is discontinuous (e.g., the fence has a gap), the processing engine 112 may determine that the passenger can pass through the fence to get on or get off the vehicle. In some embodiments, the processing engine may further determine a height of the road element. For example, if the identification result is that a fence is present around the candidate location, the processing engine 112 may determine whether the height is greater than a height threshold. For example, the height threshold may indicate whether a passenger can step over the fence. The height threshold may be a default height or determined manually or by the processing engine 112. In some embodiments, the height of the fence may be determined according to a model trained by a plurality of manually labeled samples.

In 540, the processing engine 112 (e.g., the processor 220, the recommended location determining module 440) may determine whether the candidate location is a recommended location based on the identification result.

In some embodiments, if the road element that forbids a driver to stop a vehicle, or prevents a passenger from getting on the vehicle is present around the candidate location, the processing engine 112 may determine that the driver cannot stop a vehicle to pick up or drop off the passenger at the candidate location. The processing engine 112 may determine that the candidate location is not reasonable/not operable to recommend to a user (e.g., a passenger, a driver, etc.) of the online to offline service. In some embodiments, the processing engine 112 may determine another candidate location that is accessible and nearest to the candidate location as the recommended location to recommend to the user of the online to offline service.

In some embodiments, if the identification result is that the road element is not present around the candidate location, the processing engine 112 may determine that the driver can stop a vehicle to pick up or drop off the passenger at the candidate location. The processing engine 112 may determine that the candidate location is reasonable/operable as a recommended location, and may recommend the candidate location the user.

In some embodiments, the processing engine 112 may further instruct a plurality of vehicle recorders to capture videos and/or images. Each of the plurality of vehicle recorders may obtain a plurality of images showing sights around the candidate location. For the plurality of images obtained by each of the plurality of vehicle recorders, the processing engine 112 may determine a sub-result as whether a road element is present around the candidate location. The method for determining the sub-result may be same as the method for determining the identification result illustrated in operation 530 in the present disclosure. The processing engine 112 (e.g., the result verifying module 460) may verify the identification result based on the plurality of sub-results to improve an accuracy of the identification. For example, if a fourth predetermined number of sub-results indicate that the road element is present around the candidate location, the processing engine 112 may determine that the identification result is that the road element is present around the candidate location. Otherwise, the processing engine 112 may determine that the sub-results include wrong identifications of the road element, and determine that identification result is that the road element is not present around the candidate location. For example, in one or more images, a row of bikes may be identified as a fence in some cases. In some embodiments, the verification based on the plurality of vehicle recorders may improve the identification accuracy.

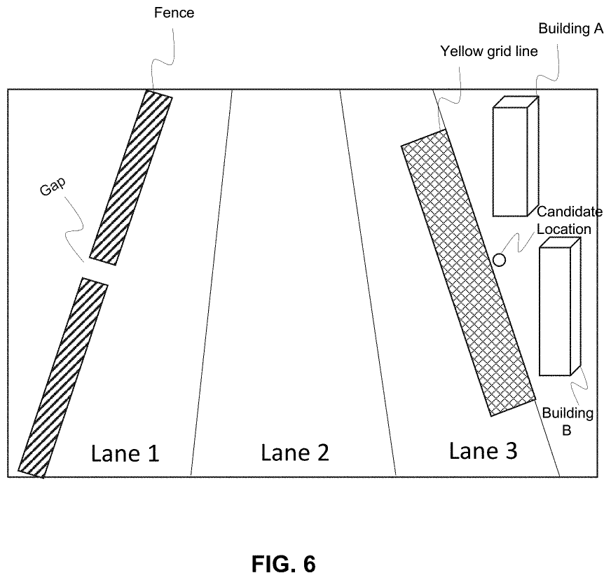

FIG. 6 is a schematic diagram illustrating an exemplary image showing sights around a candidate location according to some embodiments of the present disclosure. The exemplary image may be captured from the at least one vehicle recorder. As shown in the FIG. 6, the candidate location (shown as a circle) may be at the right side of a road (comprising lane 1, lane 2, and lane 3), and between building A and building B (shown as a cuboid respectively).

In some embodiments, the candidate location as shown in FIG. 6 may be determined based on historical order data. The candidate location may be used by a plurality of historical passengers in the history. As shown in FIG. 6, the processing engine 112 may determine that a fence (shown as rectangles with slashes) and/or a yellow grid line (shown as a rectangle with meshes) are present around the candidate location. For example, after determining that the fence is present around the candidate location, the processing engine 112 may determine a location, or an area of the fence. The processing engine 112 may determine that fence is on the left side of lane 1 of the road, the fence has a gap. The processing engine 112 may determine that a passenger may pass across the road through the gap of the fence from the left side of the road to the candidate location on the right side of the road. The processing engine 112 may determine that the candidate location is reasonable/operable as a recommended location to recommend to a passenger or a driver. As another example, after determining that the yellow grid line is present around the candidate location, the processing engine 112 may determine a location of the yellow grid line. The processing engine 112 may determine that the yellow grid line is on the right side of the road in front of the building A and the building B. The processing engine 112 may determine that the yellow grid line is present in front of the candidate location, and a driver may not stop a vehicle to pick up or drop off a passenger. The processing engine 112 may determine that the candidate location is not reasonable/not operable as a recommended location to recommend to a passenger or a driver.

It should be noted that FIG. 6 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one image showing sights around a candidate location may include at most one road element. The processing engine 112 may determine whether the road element is present around the candidate location. As another example, one image showing sights around a candidate location may include at least one road element. The processing engine 112 may determine whether any one road element is present around the candidate location.

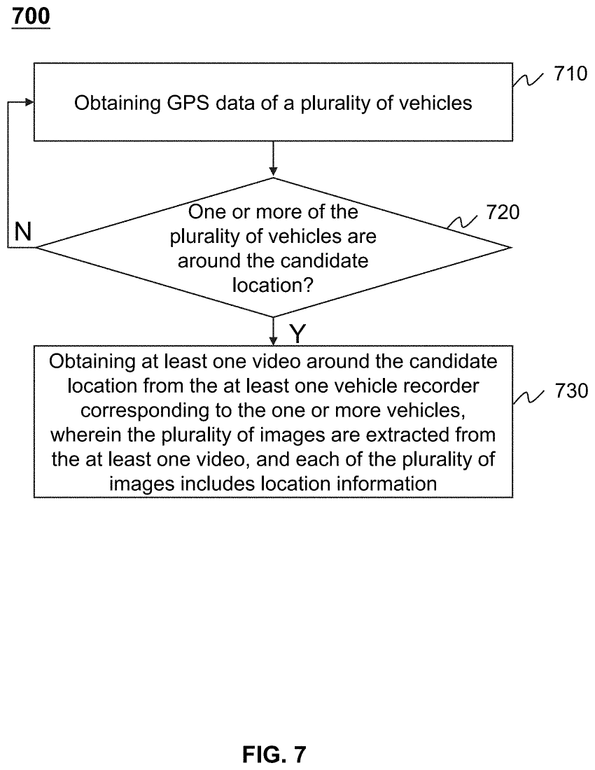

FIG. 7 is a flowchart illustrating an exemplary process for determining whether to obtain at least one video around a candidate location according to some embodiments of the present disclosure. The process 700 may be executed by the online to offline system 100. For example, the process 700 may be implemented as a set of instructions (e.g., an application) stored in the storage ROM 230 or RAM 240. The processor 220 may execute the set of instructions, and when executing the instructions, it may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process as illustrated in FIG. 7 and described below is not intended to be limiting.

In 710, the processing engine 112 (e.g., the processor 220, the image obtaining module 420) may obtain GPS data of a plurality of vehicles. In some embodiments, the plurality of vehicles may be vehicles of the online to offline service.

In some embodiments, the GPS data may indicate real-time locations of the plurality of vehicles. For example, the GPS data may include coordinates of the plurality of vehicles and corresponding time obtaining the coordinates. The GPS data of a vehicle of the plurality of vehicles may be obtained by an electronic device with positioning technology for locating the position of the vehicle. For example, the electronic device may include a user terminal 130 associated with the vehicle, an onboard positioning device of the vehicle, a vehicle recorder 140 of the vehicle, or the like, or any combination thereof.

In 720, the processing engine 112 (e.g., the processor 220, the image obtaining module 420) may determine whether one or more of the plurality of vehicles are around the candidate location.

In some embodiments, for each of the plurality of the vehicles, the processing engine 112 may determine whether the vehicle is around the candidate location or on a planned route to the candidate location. For example, the processing engine 112 may obtain real-time locations of the vehicle from the obtained GPS data, and determine whether the real-time locations are within a first predetermined distance from the candidate location. The first predetermined distance may be a default distance stored in a storage device (e.g., the storage 150, the storage 390). Additionally or alternatively, the first predetermined distance may be set manually or be determined by one or more components of the online to offline system 100 according to different situations. For example, the first predetermined distance may be determined according to different areas or roads. In some embodiments, if the real-time locations of a vehicle are within the first predetermined distance from the candidate location, and the driver of the vehicle is driving towards the candidate location, the processing engine 112 may determine that the vehicle is around the candidate location.

In response to a determination that the one or more vehicles are around the candidate location, in 730, the processing engine 112 (e.g., the processor 220, the image obtaining module 420) may obtain at least one video around the candidate location from the at least one vehicle recorder corresponding to the one or more vehicles. In some embodiments, the plurality of images may be extracted from the at least one video. Each of the plurality of images may include location information.

In some embodiments, for each of the one or more vehicles, the processing engine 112 may obtain a video from the corresponding vehicle recorder when the vehicle is within the first predetermined distance from the candidate location. The processing engine 112 may stop obtaining the video when the vehicle is driving outside a second predetermined distance from the candidate location. The second predetermined distance may be a default distance stored in a storage device (e.g., the storage 150, the storage 390). Additionally or alternatively, the second predetermined distance may be set manually or be determined by one or more components of the online to offline system 100 according to different situations. The first predetermined distance and the second predetermined distance may be same or different.

In some embodiments, the processing engine 112 may extract the plurality of images from the obtained at least one video. For example, the processing engine 112 may select a third predetermined number of images from the obtained at least one video. The processing engine 112 may extract an image from the obtained at least one video every several seconds or every several distance intervals to obtain the plurality of images. As another example, the processing engine 112 may select a third predetermined number of images from the obtained images. The third predetermined number may be a default number stored in a storage device (e.g., the storage 150, the storage 390). Additionally or alternatively, the third predetermined number may be set manually or be determined by one or more components of the online to offline system 100 according to different situations. For example, the processing engine 112 may select the third predetermined number of images that have high qualities (e.g., the images are clear showing sights around the candidate location, the images are captured in bright light, etc.) as the plurality of images, in order to improve efficiency and accuracy of an identification result whether a road element is present around the candidate location in the plurality of images.

In some embodiments, each of the plurality of images may include location information. For example, each of the plurality of images may include coordinates, a relative position to the candidate location, or the like, or any combination thereof. The location information may be determined based on the GPS data of the corresponding vehicle.

In response to a determination that the one or more vehicles are not around the candidate location, the processing engine 112 (e.g., the processor 220, the image obtaining module 420) may proceed to operation 710 to obtain the GPS data of the plurality of vehicles. The obtaining of the GPS data may be stopped until the processing engine 112 determine that one or more of the plurality of vehicles are around the candidate location.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the descriptions, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and describe.

1. A system for determining a recommended location, comprising:
at least one network interface to communicate with at least one vehicle recorder;
at least one storage medium including a set of instructions; and
at least one processor in communication with the at least one storage medium and operably connected to the at least one network interface, wherein when executing the set of instructions, the at least one processor is directed to:
identify a candidate location based on historical order data of a plurality of historical passengers;
obtain a plurality of images, via the at least one network interface, showing sights around the candidate location, wherein the plurality of images are captured by the at least one vehicle recorder;
determine an identification result as to whether a road element is present around the candidate location based on the plurality of images; and
determine whether the candidate location is a recommended location based on the identification result.

2. The system of claim 1, wherein to determine the identification result, the at least one processor is further directed to:
for each of the plurality of images, identify whether the road element is present around the candidate location based on a deep learning neural network.

3. The system of claim 1, wherein the identification result is that the road element is not present and the candidate location is determined as the recommended location.

4. The system of claim 1, wherein the identification result is that the road element is present and the at least one processor is further directed to:
determine at least one of:
a location of the road element;
an area of the road element; or
a height of the road element.

5. The system of claim 4, wherein the road element is a fence, and the at least one processor is further directed to:
determine that the area of the fence is discontinuous; and
determine that the candidate location is the recommended location.

6. The system of claim 1, wherein the road element includes at least one of: a fence, an electronic eye, a traffic light, a traffic sign, a yellow grid line, or a no-stop line along the road.

7. The system of claim 1, wherein the at least one processor is further directed to:
send an instruction to the at least one vehicle recorder via the at least one network interface to record the images, wherein one of the at least one vehicle recorder is mounted on a vehicle.

8. The system of claim 7, wherein the at least one processor is further directed to:
obtain GPS data of a plurality of vehicles via the at least one network interface; and
determine whether one or more of the plurality of vehicles are around the candidate location based on the GPS data.

9. The system of claim 8, the at least one processor is further directed to:
in response to a determination that the one or more vehicles are around the candidate location, obtain at least one video around the candidate location from the at least one vehicle recorder corresponding to the one or more vehicles;
wherein the plurality of images are extracted from the at least one video, and each of the plurality of images includes location information.

10. The system of claim 7, wherein the at least one processor is further directed to:
obtain a trigger condition to send the instruction to the at least one vehicle recorder, wherein the trigger condition includes a complaint from a passenger or a feedback from a driver.

11. The system of claim 1, wherein to determine the identification result, the at least one processor is further directed to:
for each of the at least one vehicle recorder, obtain at least one image, via the at least one network interface, showing sights around the candidate location, wherein the at least one image is captured by the vehicle record; and
verify the identification result based on the at least one image captured by each of the at least one vehicle recorder.

12. The system of claim 1, wherein the candidate location is a candidate pick-up location or a candidate drop-off location.

13. A method for determining a recommended location, comprising:
identifying a candidate location based on historical order data of a plurality of historical passengers;
obtaining a plurality of images showing sights around the candidate location, wherein the plurality of images are captured by at least one vehicle recorder;
determining an identification result as to whether a road element is present around the candidate location based on the plurality of images; and
determining whether the candidate location is a recommended location based on the identification result.

14. The method of claim 13, wherein the determining of the identification result includes:
for each of the plurality of images, identifying whether the road element is present around the candidate location based on a deep learning neural network.

15. The method of claim 13, wherein the identification result is that the road element is not present and the candidate location is determined as the recommended location.

16. The method of claim 13, wherein the identification result is that the road element is present, and the method further comprising:
determining at least one of:
a location of the road element;
an area of the road element; or
a height of the road element.

17. The method of claim 16, wherein the road element is a fence, and the method further comprising:
determining that the area of the fence is discontinuous; and
determining that the candidate location is the recommended location.

18. The method of claim 13, wherein the road element includes at least one of: a fence, an electronic eye, a traffic light, a traffic sign, a yellow grid line, or a no-stop line along the road.

19. The method of claim 13, further comprising:
sending an instruction to the at least one vehicle recorder to record the images, wherein one of the at least one vehicle recorder is mounted on a vehicle.

20-24. (canceled)

25. A non-transitory computer readable medium, comprising at least one set of instructions compatible for determining a recommended location, wherein when executed by at least one processor of one or more electronic device, the at least one set of instructions directs the at least one processor to:
identify a candidate location based on historical order data of a plurality of historical passengers;
obtain a plurality of images showing sights around the candidate location, wherein the plurality of images are captured by at least one vehicle recorder;
determine an identification result as to whether a road element is present around the candidate location based on the plurality of images; and
determine whether the candidate location is a recommended location based on the identification result.

26. (canceled)
